(19) United States
(12) Patent Application Publication
(10) Pub. No.: US 2007/0014707 A1
(43) Pub. Date: Jan. 18, 2007

(54) Retention matting assembly methods

(76) Inventors: Eric C. Schultz, Flushing, MI (US); Rick P. Schacher, Flint, MI (US)

Correspondence Address: Paul L. Marshall;Delphi Technologies, Inc., M/C 480-410-202, P.O. Box 5052, Troy, MI, 48007, US

(21) Appl. No.: 11/180,852

(22) Filed: Jul. 13, 2005

(51) Int. Cl. B01D 53/34

(52) U.S. Cl. 422/179; 29/890

(57) ABSTRACT

In one embodiment, an exhaust treatment device comprises: a housing, a substrate disposed within the housing, and a mat wrapped around the substrate in a helical configuration, wherein the mat has a length that is greater than or equal to about three times the mat width and is disposed between the substrate and the housing. In another embodiment, a method for producing an exhaust treatment device comprises winding a mat around a substrate in a helical configuration to form a substrate/mat sub-assembly and disposing said substrate/mat sub-assembly in a housing. The mat has a length that is greater than or equal to about three times the mat width and is disposed between the substrate and the housing.

### TECHNICAL FIELD

This disclosure generally relates to methods of assembling exhaust treatment devices. More particularly, methods of assembling retention matting around a substrate and the benefits derived there from.

### BACKGROUND

Exhaust treatment devices have demonstrated to be effective at remediating emissions produced by internal combustion engines. Emissions such as, carbon monoxide (CO), carbon dioxide (CO₂), nitrogen oxides (NOx), and the like, can be catalytically converted to less undesirable species or compounds within the substrate of the exhaust treatment device at high temperatures in the presence of catalytic metals.

Substrates are generally fabricated utilizing materials such as, but not limited to, cordierite, silicon carbides, metal oxides, and the like, which are capable of withstanding elevated operating temperatures of about 600° Celsius in underfloor applications to about 1,000° Celsius in manifold mounted or close coupled applications. Substrates are designed to comprise a large surface area to encourage a high percentage of conversion and can be designed in many forms, such as, but not limited to, foils, preforms, fibrous material, monoliths, porous glasses, glass sponges, foams, pellets, particles, molecular sieves, and the like.

Generally, substrates are assembled within a metal housing (a.k.a shell or can). The housing encases the substrate and can be attached on either end with funnel-shaped components called “end-cones”. Attached to the end-cones are “snorkels” which allow easy assembly to exhaust conduit.

Due to differentials in expansion between the substrate and the metal housing, a gap can form between the substrate and the housing allowing exhaust to flow therethrough, decreasing the efficiency of the device. To remedy this differential in expansion, matting can be used to support the substrate within the housing. The matting can be composed of any material compatible with the use environment and capable of providing sufficient retention, and thermal insulation, such as an extrudable ceramic substance (CORDERITE®, commercially available from NGK-Locke, Inc., Corning, N.Y.), and/or other materials including fibers (e.g. chopped, random, woven, non-woven, preforms, etc.), as well as combinations comprising at least one of the foregoing, and the like. Furthermore, mat materials may be intumescent and expand with the application of heat such as those commercially available from 3M, Minneapolis, Minn.

Intumescent matting, which can comprise vermiculite fibers, expands to decrease or eliminate the flow of exhaust around the substrate during operation. The expansion characteristic of the matting also offers increased axial retention of the substrate. This is beneficial as high pressures can be generated during use, which can result in high axial forces acting on the substrate. In addition, intumescent matting also provides improved impact resistance, and insulation from heat loss through the outer housing.

Exhaust treatment devices can be assembled utilizing various methods. Three such methods are; stuffing, clamshell, and tourniquet assembly methods. The stuffing method generally comprises pre-assembling the matting around the substrate and pushing, or stuffing, the assembly into the housing through a stuffing cone. The stuffing cone serves as an assembly tool, which attaches to one end of the housing that the substrate/mat assembly can pass therethrough. The inside cross-sectional geometry of the stuffing cone can be equal to that of the housing at the housing's rim where the stuffing cone attaches to the housing. From this area, the stuffing cone then gradually increases in diameter away from the housing's rim along the stuffing cone's length. This provides an easy taper that is capable compressing the matting to the respective cross-sectional area of the housing as the substrate/mat assembly is inserted into the housing.

A second method of assembly is the clamshell assembly method. This method also generally utilizes a pre-assembled sub-assembly of the matting around a substrate. After the substrate/mat sub-assembly has been produced, the sub-assembly is encapsulated within two mating housing halves that, when assembled, comprise the converter housing.

Another method of assembly is the tourniquet assembly method. Again, the tourniquet method generally utilizes a pre-assembled sub-assembly the matting around the substrate. Once fabricated, a steel sheet can be wrapped around the substrate/mat sub-assembly and fastened at a seam to comprise the converters housing.

As described above in the various assembly methods, pre-assembly of a substrate/mat sub-assembly can occur prior to inserting the assembly into the housing. The substrate/mat sub-assembly can be fabricated by cutting a sheet of matting equal in width to the length of the substrate and of a length equal to circumference of the substrate and then wrapping the sheet around the substrate. Although uncomplicated, every mat is custom cut for their respective substrate design. As a result, as the number of different mat and substrate configurations increase, manufacturers experience the consequences of non-standardization, such as; increased tooling costs, increased frequency of tooling change-overs, increased training and procedural costs, and an increased potential of assembly errors caused by improper process set-up.

To reduce or eliminate these consequences, manufacturers desire mat assembly methods capable of assembling a standard mat to various substrate designs.

### BRIEF SUMMARY

Disclosed herein are exhaust treatment devices and methods of making the same.

In one embodiment, an exhaust treatment device comprises: a housing, a substrate disposed within the housing, and a mat wrapped around the substrate in a helical configuration, wherein the mat has a length that is greater than or equal to about three times the mat width and is disposed between the substrate and the housing.

In another embodiment, a method for producing an exhaust treatment device comprises winding a mat around a substrate in a helical configuration to form a substrate/mat sub-assembly. The mat has a length that is greater than or equal to about three times the mat width and is disposed between the substrate and the housing.

In another embodiment, an exhaust treatment device comprises: a housing, a substrate disposed within said housing, and a layered mat disposed between the substrate and the housing, wherein the layered mat is wrapped around said substrate greater than or equal to two revolutions.

In another embodiment, a method for producing an exhaust treatment device, comprising: wrapping a mat around a substrate greater than or equal to two revolutions to form a substrate/layered mat sub-assembly, and disposing said substrate/layered mat sub-assembly into a housing.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustration of an exemplary substrate/mat sub-assembly.

FIG. 2 comprises illustrations of exemplary cross-sectional shapes of mat (4).

FIG. 3 is a partial cross-sectional illustration of an exemplary substrate/mat sub-assembly (6).

FIG. 4 is a partial cross-sectional illustration of an exemplary combination mat/substrate sub-assembly (6).

FIG. 5 is a partial cross-sectional illustration of an exemplary exhaust treatment device 26.

### DETAILED DESCRIPTION

Two embodiments for assembling matting over substrates are disclosed herein that offer increased flexibility and efficiency compared to methods which cannot employ a standard mat for assembly onto various substrate designs. The first method comprises coiling a length of matting around the substrate until the desired length or layers is achieved. The second method comprises wrapping a thin sheet of matting around a substrate until the desired thickness is achieved.

Disclosed herein are various references to “mat”, “matting”, or “intumescent” materials. Despite terminological differences, these materials are intended to be any materials that can secure a substrate within an exhaust treatment device, such as, but not limited to, intumescent materials, non-intumescent materials, and the like. Furthermore, the term “helical” used herein means a winding (e.g., around a substrate) that results in a constantly changing series of longitudinal planes. In addition, ranges will be disclosed which are inclusive and combinable (e.g., ranges of “up to about 25 wt %, with about 5 wt % to about 20 wt % desired”, is inclusive of the endpoints and all intermediate values of the ranges of “about 5 wt % to about 25 wt %,” etc). Furthermore, the terms “a” and “an” herein do not denote a limitation of quantity but rather denote the presence of the referenced entity.

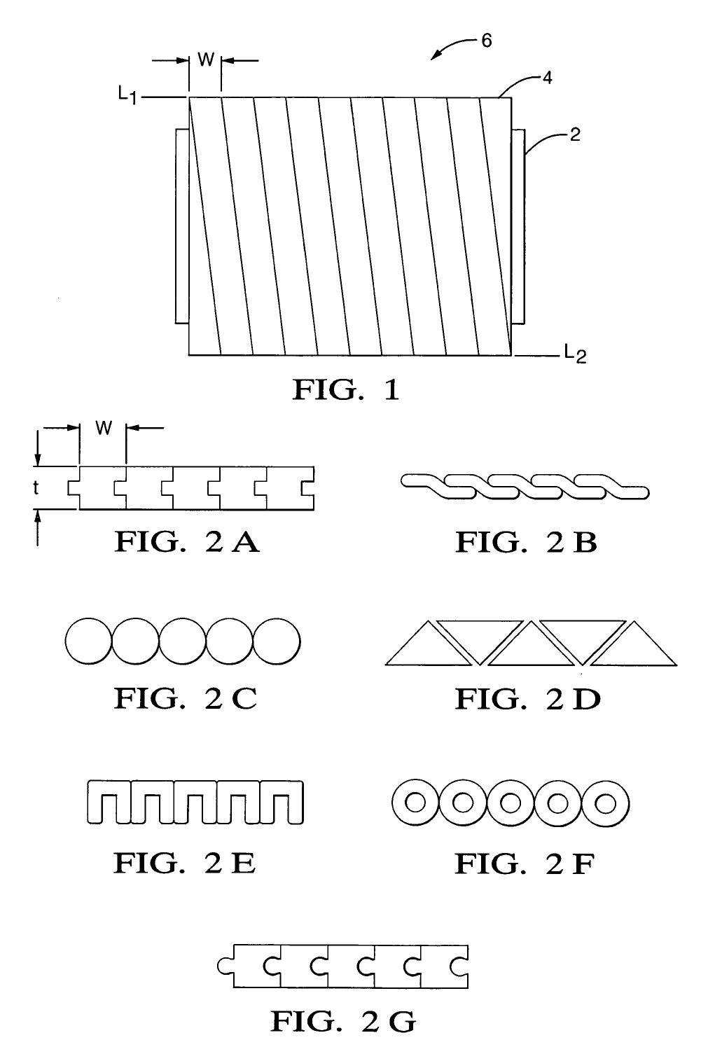

Referring now to FIG. 1, an assembly view of an exemplary substrate/mat sub-assembly, generally designated 6, is illustrated. In this illustration, substrate (2) is shown encased by mat (4), which is helically wound around substrate (2). The method of winding mat (4) around the substrate (2) allows for an assembly operation that can be easily adapted for various substrate (2) configurations.

In FIG. 1, the ends of mat (4) are cut on a taper to provide a substrate/mat sub-assembly (6) with relatively square ends. This is intended as one potential and exemplary configuration. It is to be noted that the ends of mat (4) can be cut or shaped in any manner (e.g. blunt ends, tapered ends, flattened ends, or the like as well as combinations comprising at least one of the foregoing) that is desired. Furthermore, mat (4) may be fixated to itself and/or to substrate (2) by mechanical methods, for example, adhesives (e.g., tape, bonding agents, and the like), binders (e.g. rivets, screws, clamps, pins, sutures, staples, and the like), wrappings (e.g. films, meshes, filaments, strands, and the like), or mat (4) can be bound by inserting the end of the mat (4) beneath the subsequent coil, and the like, as well as combinations comprising at least one of the forgoing.

The cross-sectional shape of mat (4) may be of any shape, such as, but not limited to, rounded (e.g., circular, elliptical, and the like), polygonal (e.g., square, trapezoidal, and the like), irregular, or the like. Moreover, the cross-sectional shape of mat (4) can comprise a geometry that overlaps itself, such as, but not limited to the exemplary embodiments illustrated in FIGS. 2a, 2b, 2d, and 2g. FIG. 2a depicts a “tongue and groove” shaped section. FIG. 2b depicts a “tape-like” shaped section, FIG. 2c depicts a circular shaped section. In addition, the cross-sectional shapes of mat (4) can comprise multiple intermeshing geometries that can be produced by multiple mats 4 wound simultaneously or non-simultaneously, such as the intermeshing triangular shaped sections depicted in FIG. 2d. The cross-sectional shapes of mat (4) can also be configured to provided additional benefits, such as, but not limited to, improved insulation, varying density, improved retention, easier assembly, and the like, for example, FIG. 2e depicts a “U” shaped section and FIG. 2f depicts a “O” shaped section, which can be hollow or filled, both of which offer additional insulative dead space, and, FIG. 2g depicts a snap-fit shaped section. Although most are illustrated in single-layer configurations, it is apparent that multiple layers can be employed in any configuration. Mat (4) has a length (l₁ to l₂) that is substantially greater than its width (w). (See FIGS. 1 and 2a), and can have a length that is greater than or equal to about three times its width (i.e., 3w), or, more specifically greater than or equal to 5w, or, even more specifically greater than or equal to 8w, and, yet more specifically greater than or equal to 10w. The thickness (t) of mat (4) is dependent upon the desired mat density and the number of layers of the mat to be employed (See FIG. 2a).

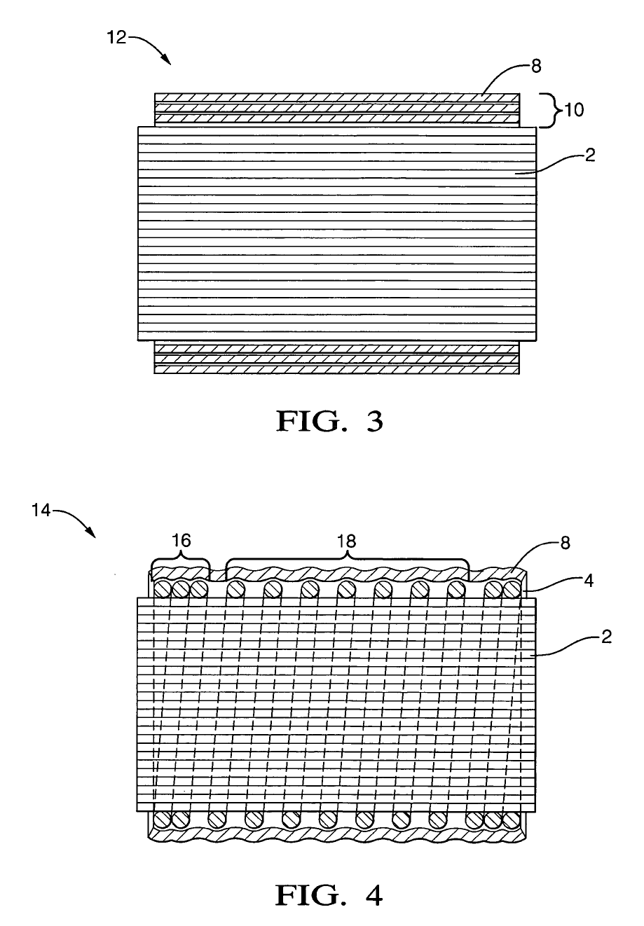

Referring now to FIG. 3, a cross-sectional view of an exemplary substrate/layered mat sub-assembly, generally designated 12, is illustrated. In the illustration substrate (2) is encased by layered mat (8). Layered mat (8) can comprise a single sheet of matting that is wound around substrate (2) multiple times to increase the layered mat thickness 10, or multiple sheets can be layered on one another to increase the layered mat thickness 10. Furthermore, if desired, layered mat (8) can be secured to itself and/or to substrate (2) utilizing any common means, such as, but not limited to, adhesives, pins, sutures, staples, films, tapes, meshes, filaments, strands, and the like.

In FIG. 3 the cross-section of each individual layer of layered mat (8) is illustrated as a simple rectangle, however, it is intended that the cross-section of layered mat (8) may be of any cross-sectional geometry (e.g. a wave-like pattern, a thickening and thinning pattern, a ribbed pattern, and the like), or the cross-section can be any pattern which results from surface features of the layered mat (8), such as, but not limited to, dimples, ribs, holes, cut-outs, bumps, and the like as well as combinations comprising at least one of the foregoing.

Referring now to FIG. 4, a cross-sectional view of an exemplary combination mat/substrate sub-assembly, generally designated 14, is illustrated. In this illustration, a substrate (2) is encased by a combination of both mat (4) and layered mat (8). Combinations of these matting configurations can comprise any configuration of layers and/or coils and can comprise any number of layers of each. In the illustration, one exemplary configuration is depicted which comprises a mat (4) having a circular cross-sectional geometry coiled about substrate (2) in a variable pitch pattern with a single layer of layered mat (8) disposed thereon. As illustrated, the variable pitch pattern comprises ends that are of tight pitch sections 16 and a center section that is a loose-pitch section 18. Tight pitch sections 16 can expand with heat forming higher-density zones as adjacent windings compress against one another and against the substrate (2), which can increase retention forces on substrate (2). Similarly, the windings of the loose-pitch section 18 can expand with heat as well, however the individual windings expand into the interstices between the individual windings forming lower-density zones, which do not add significant retention force, however can add increased insulation compared to higher-density zones.

Although not shown in FIG. 4, layered mat (8) can be secured to itself and/or to substrate (2) and/or to mat (4) as described above with respect to mat (4).

During the manufacturing process of winding or wrapping the embodiments disclosed, or combinations of the embodiments disclosed, it is envisioned that the processing variables can affect the properties of the final product. These variables, such as, but not limited to; tension, pressure, feed rate, pitch, application angle (angle of matting stock during winding in relation to previous coil), and the like, are therefore controllable by the manufacturer in order to tailor the final device's properties.

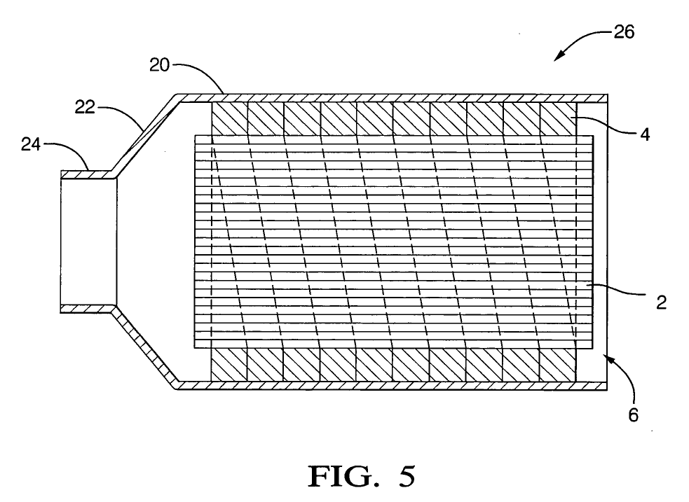

FIG. 5 illustrates a partial, cross-sectional view of an exemplary exhaust treatment device, generally designated 26. Although any configuration of substrate (2), mat (4) and/or layered mat (8) can be used, exhaust treatment device 26 comprises substrate/mat sub-assembly (6) which is contained within three housing components; housing (20), end-cone 22, and snorkel 24. These housing components generally serve to house, protect, and connect the device to an exhaust source, and can be fabricated of any materials capable of withstanding the temperatures, corrosion, and wear encountered during normal operation of the exhaust treatment device 26. Suitable materials can be, but are not limited to, ferrous metals or ferritic stainless steels (e.g., martensitic, ferritic, and austenitic stainless materials, and the like). It is intended that these components may be assembled, fixed, or mounted to one another by any means, such as, fastening, swaging, stamping, press-fitting, screwing, snapping, welding, fusing, clamping, bolting, riveting, doweling, pinning, crimping, peening, and the like. It is also envisioned that housing (20), end-cone 22, and snorkel 24, can be of one continuous material (e.g. spin-formed).

Substrate (2) can be coaxially disposed within housing (20) and can comprise any material suitable for the operating environment and desired substrate function. Possible substrate materials comprise, but are not limited to, cordierite, silicon carbide, mullite, alpha-aluminum oxides, alumino silicates, aluminum phosphates, aluminum titanates, aluminosilicates, zirconium oxides, zirconium phosphates, titanium oxides, titanium phosphates, magnesium silicates, as well as combinations comprising at least one of the foregoing materials.

Disposed on and/or in the substrate can be catalyst(s), zeolite(s), stabilizing agent(s), and the like. The catalysts can comprise metals, such as, platinum, palladium, rhodium, iridium, osmium, ruthenium, tantalum, zirconium, yttrium, cerium, nickel, manganese, copper, and the like, as well as oxides, alloys, and combinations comprising at least one of the foregoing catalyst materials, and other catalysts. Some particularly useful nitrous oxide catalysts and three-way conversion catalysts are commercially available from Delphi Catalyst, Tulsa, Okla.

Exhaust treatment device 26 can be assembled utilizing any method employed for producing exhaust treatment devices. In the embodiment illustrated, it is envisioned that substrate/mat sub-assembly (6) is pre-assembled and inserted into housing (20) utilizing a stuffing process, however, any assembly technique can be utilized, such as, but not limited to, a clamshell or tourniquet assembly methods, or the like.

The embodiments described herein offer cost-effective and flexible methods of attaching matting to substrates of varying geometries, thereby reducing or eliminating the need for a specific mat (4) design for every substrate (2) configuration. These methods decrease tooling costs, the frequency of tooling changeovers, manufacturing training and procedural costs, and decrease the potential of assembly errors caused by improper process set-up. More specifically, the first embodiment disclosed a method of coiling a mat around a substrate (2) using a mat (4). This method offers several of the aforementioned benefits, such as; standardization of matting, the capability to wind the matting around various substrate (2) configurations, offering the manufacturer the ability to tailor the properties of the final product by altering the cross-sectional geometry of the mat (4), and the ability to adjust the thickness of the final product through the application of multiple layers. This method also has an inherent benefit not initially recognizable; due to the lengthy seam of the mat (4), exhaust flow around the substrate through the seam is reduced or most likely eliminated compared to alternate designs.

The second embodiment disclosed herein is a layered mat (8) that can be wrapped around a substrate multiple times (e.g., greater than or equal to two revolutions) to produce the desired matting thickness. This method also offers a versatile manufacturing process that is capable of wrapping various substrate geometries, and can offer a manufacturer the capability of standardizing matting materials. In this embodiment as well, the manufacturer can tailor the properties of the final product by determining the inner diameter of the housing (20) and the outer diameter of the substrate (2), and then determining a number of revolutions that will meet a desired mat density. In addition, the mat can be adjusted to attain the desired result, e.g., by altering the layered mat's cross-sectional and/or surface geometries and/or adjusting the thickness of the final mat by increasing or decreasing the number of layers applied to the substrate (2).

It has also been disclosed that these methods can also be combined to produce combination assemblies that comprise combinations of mat (4) and layered mat (8) components (e.g., a mat that has a length that is equal to greater than or equal to 3 times its width (when disposed on the substrate; in other words, a width that is less than or equal to about 33% of the length of the substrate; or, more specifically, less than or equal to about 25% of the length of the substrate, and even more specifically, less than or equal to about 10% of the length of the substrate (e.g. measured in the flow direction)), and a mat that has a width that is greater than or equal to about 75% of the substrate), producing additional options for the manufacturer to tailor the devices properties.

These methods offer cost-effective, and flexible solutions for manufacturers desiring to standardize the matting utilized for exhaust treatment devices 26 that employ substrates. These methods decrease tooling costs, frequency of tooling changeovers, manufacturing training and procedural costs, and decrease the potential of assembly errors caused by improper process set-up, and therefore are a desirable innovation for manufacturers.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An exhaust treatment device, comprising:
a housing,
a substrate disposed within said housing; and,
a first mat wrapped around said substrate in a helical configuration, wherein said mat has a length that is greater than or equal to about three times the mat width and is disposed between the substrate and the housing.

2. The device of claim 1, wherein the length that is greater than or equal to about five times the mat width.

3. The device of claim 2, wherein the length that is greater than or equal to about ten times the mat width.

4. The device of claim 1, further comprising a second mat disposed between said substrate and said housing, wherein said second mat has a width of greater than or equal to about 75% of a length of said substrate.

5. The device of claim 4, wherein said second mat is disposed between said first mat and said substrate.

6. A method for producing an exhaust treatment device, comprising:
winding a mat around a substrate in a helical configuration to form a substrate/mat sub-assembly, wherein said mat has a length that is greater than or equal to about three times the mat width and is disposed between the substrate and the housing; and,
disposing said substrate/mat sub-assembly in a housing.

7. The method of claim 6, wherein the length that is greater than or equal to about five times the mat width.

8. The method of claim 7, wherein the length that is greater than or equal to about ten times the mat width.

9. The method of claim 6, further comprising a second mat disposed between said substrate and said housing, wherein said second mat has a width of greater than or equal to about 75% of a length of said substrate.

10. An exhaust treatment device, comprising:
a housing,
a substrate disposed within said housing; and,
a layered mat disposed between the substrate and the housing, wherein the layered mat is wrapped around said substrate greater than or equal to two revolutions.

11. A method for producing an exhaust treatment device, comprising:
wrapping a mat around a substrate greater than or equal to two revolutions to form a substrate/layered mat sub-assembly; and,
disposing said substrate/layered mat sub-assembly into a housing.

12. The method of claim 11, further comprising:
determining an inner diameter of said housing;
determining an outer diameter of said substrate;
determining a number of revolutions of said mat that will attain a desired mat density;
wrapping said substrate with said mat said number of revolutions.
